(19) United States
(12) Patent Application Publication
(10) Pub. No.: US 2026/0229210 A1
(43) Pub. Date: Aug. 6, 2026

(54) LOUDSPEAKER AND METHOD FOR SPREADING A SOUND

(71) Applicant: POWERSOFT S.P.A., SCANDICCI (FIRENZE) (IT)

(72) Inventor: CLAUDIO LASTRUCCI, SCANDICCI (FIRENZE) (IT)

(21) Appl. No.: 19/137,872

(22) PCT Filed: Dec. 19, 2023
(86) PCT No.: PCT/IB2023/062942

§ 371 Date: Jun. 11, 2025

(30) Foreign Application Priority Data
Dec. 20, 2022 (IT) 102022000026061

(51) Int. Cl. G10K 11/00; H04R 1/34; H04R 9/02; H04R 9/06

(52) U.S. Cl. CPC G10K 11/002; H04R 1/345; H04R 9/025; H04R 9/06

(57) ABSTRACT

A loudspeaker includes a stationary structure, including a magnetic field generator; a movable working unit, including a radiator, movable along a longitudinal axis, and a movable magnetic element, connected to the radiator and movable under the action of the magnetic field to form a transducer; a guiding device, configured to guide the longitudinal reciprocating movement of the movable working unit. The guiding device includes an inside surface, extending around a guide axis which is oriented longitudinally; an outside surface, extending around the guide axis and surrounding the inside surface to define a gap; a spring, closed on itself to form a ring, disposed in the gap in contact with the inside surface and the outside surface to roll on them while moving longitudinally responsive to a relative movement between the inside surface and the outside surface.

### TECHNICAL FIELD

This invention relates to a loudspeaker and to a method for spreading a sound.

### BACKGROUND ART

Generally speaking, loudspeakers comprise an electromechanical transducing system to convert a variable electrical signal into a mechanical movement of a radiator in order to generate a sound wave. These transducing systems have a magnetic element which is integral with the fixed parts of the sound diffuser and a magnetic element which is connected to the radiator to move it; in particular, the movable magnetic element moves under the action of the magnetic field generated by the integral magnetic element.

In this context, there are two types of electromechanical transducing systems. In the more common system, known as “moving coil” system, the integral magnetic element is a permanent magnet, while the movable magnetic element is a coil; the coil is energized by the electric signal to be transduced and moves in response to the interaction with the magnetic field generated by the permanent magnet. One example of a moving coil system is described in patent document US5014323A. Alternatively, in what is known as a “moving magnet” system, the integral magnetic element is a fixed coil, while the movable magnetic element is a magnet; the fixed coil is energized by the electric signal and the moving magnet moves in response to the magnetic field generated by the coil. One example of a moving magnet system is described in patent document EP2550724, in the name of the present Applicant.

Loudspeakers may comprise centring systems between components which move relative to each other. The centring systems must ensure that the relative motion between the components is as precise and friction-free as possible. The absence of friction is important to prevent undesirable noise and to reduce component wear.

US5014323A describes a moving coil system comprising a centring system, called a spider, such centring systems, however, tend to break easily, creating the need for frequent repairs.

The moving magnet system described in EP2550724 discloses a centring system comprising ball bearings. The ball bearings also act as slide guides between the moving part and the fixed part of the loudspeaker. Guides of this kind, however, have the disadvantage of being very noisy on account of the effect of inactive ball recirculation; moreover, such guides are characterized by high inertia and are subject to wear caused by the friction resulting from frequent changes of direction and high accelerations. Patent documents US2022030351A1, US2021044902A1 and JPH04255197A describe different examples of loudspeakers; none of these satisfactorily meets market needs, however.

### Aim of the Invention

The aim of this invention is to provide a loudspeaker and a method for spreading a sound to overcome the above mentioned disadvantages of the prior art.

In particular, this invention has for an aim to provide a sound diffuser capable of precisely centring the parts in motion relative to each other and of ensuring that their relative motion is as silent and reliable as possible.

These aims are fully achieved by the loudspeaker and method for spreading a sound of this disclosure, as characterized in the appended claims.

In particular, the loudspeaker comprises a stationary structure, including a magnetic field generator. The loudspeaker comprises a movable working unit, including a radiator which is movable along a longitudinal axis, and a movable magnetic element which is connected to the radiator.

The movable magnetic element is movable under the action of the magnetic field to form a transducer. In particular, the assembly comprising the movable magnetic element, the magnetic field generator and the radiator constitutes the electromechanical transducer for the loudspeaker.

The loudspeaker comprises a guiding device configured to guide the longitudinal movement of the movable working unit. Preferably, the longitudinal movement of the movable working unit is a reciprocating movement.

The guiding device includes an inside surface extending around a guide axis. Preferably, the guide axis is oriented longitudinally.

The guiding device includes an outside surface extending around the guide axis. The outside surface surrounds the inside surface to define a gap. Also imaginable is a portion of the outside surface surrounding a portion of the inside surface to define a gap between the outside surface and that portion.

In other words, the outside surface faces (that is, is directed towards) the inside surface to define a gap.

The guiding device includes a spring. The spring is closed on itself to form a ring (that is, to form a closed line) and is disposed in the gap.

The term “spring” is used generically to denote an elastic element. The elastic element may be (or is preferably) a helical element comprising a plurality of windings (for example, made from metallic material). Alternatively, the spring (that is, the elastic element) may be (or include) for example, a solid element made from elastic material (for example, an elastomer preferably having shape memory) which is annular in shape, or an (internally hollow) annular shaped tubular element made, for example, from polymeric material or rubber.

Preferably, the spring is in contact with the inside surface and with the outside surface to roll on them (on the inside surface and on the outside surface) while moving longitudinally responsive to a relative movement between the inside surface and the outside surface. The inside surface may be connected to the stationary structure and the outside surface may be connected to the movable working unit, or vice versa, that is, the inside surface may be connected to the movable working unit and the outside surface may be connected to the stationary structure.

Thus, responsive to the longitudinal movement of the movable working unit, the inside surface and the outside surface move relative to one another; the spring is interposed between the inside surface and the outside surface, inside the gap, and rolls longitudinally.

In particular, the spring comprises a plurality of windings. Preferably, each of the plurality of windings is in contact with the inside surface so as to define a plurality of internal contact points and is in contact with the outside surface so as to define a plurality of external contact points. The spring therefore constitutes an (indirect) contact element between the inside surface and the outside surface of the guiding device.

The guiding device according to this disclosure might be used to guide any relative movement between two elements which are in motion relative to each other along a guide axis (for example, it may be used in 3D printers, in linear motors, in vibration dampers, and other applications).

It is noted that the movable magnetic element may be connected to the radiator indirectly; for example, the movable magnetic element may be connected to the radiator through a homokinetic inverter so that a longitudinal movement of the movable magnetic element in a first direction corresponds to a longitudinal movement of the radiator in a second direction, opposite of the first direction.

In an example embodiment, the guiding device comprises an additional spring. The additional spring is closed on itself to form a ring, disposed in the gap in contact with the inside surface and with the outside surface to roll on them while moving longitudinally responsive to a relative movement between the inside surface and the outside surface. The spring and the additional spring define a pair of springs.

In particular, the additional spring also comprises a plurality of windings, each of which is in contact with the inside surface so as to define a plurality of internal contact points and with the outside surface so as to define a plurality of external contact points. The additional spring therefore constitutes an additional (indirect) contact element between the inside surface and the outside surface of the guiding device.

The presence of the pair of springs has the advantage of imparting stability during the relative movement between the inside surface and the outside surface (that is, between the movable working unit and the stationary structure).

In an embodiment, the loudspeaker comprises a positive terminal and a negative terminal. The positive terminal and the negative terminal may be connected to a current generator to receive current. In particular, the movable magnetic element is a coil, extending between a first end and a second end. Preferably, the pair of springs is electrically conductive, so that the inside surface defines an internal conductive path to carry the current from the positive terminal to the spring and from the negative terminal to the additional spring and wherein the outside surface defines an external conductive path to carry the current from the spring to the first end of the coil and from the additional spring to the second end of the coil. Thus, the first end of the coil is electrically connected to the positive terminal of the loudspeaker through the spring and the second end of the coil is electrically connected to the negative terminal of the loudspeaker through the second spring, so as to receive current from a generator.

In particular, the loudspeaker may comprise a first electrically insulating element, located in a first portion of the inside surface and interposed between the first portion of the inside surface and the positive terminal; the loudspeaker may comprise a second electrically insulating element, located in a second portion of the inside surface and interposed between the second portion of the inside surface and the negative terminal.

It is noted that the internal contact points and the external contact points of the windings may constitute mechanical contact points and/or electrical contact points between the inside surface, the spring (and the additional spring, when present) and the outside surface.

In an example, the guiding device is preloaded along a radial direction towards the guide axis or away from the guide axis. In other words, the guiding device is compressed, relative to a rest position, by a predetermined quantity along a radial direction towards or away from the guide axis. The preloading of the guiding device is important to ensure that there is no clearance between the components of the guiding device and to ensure constant mechanical contact between outside surface, spring (and additional spring, if present) and inside surface of the guiding device.

Furthermore, in the example embodiments where it is provided, the preloading of the guiding device is important to ensure constant and uniform contact between the components.

In an example, the spring and/or the additional spring is located in the gap so as to be compressed by a predetermined quantity relative to a rest position, along the radial direction. In particular, each of the plurality of windings may be interposed between the outside surface and the inside surface so as to be squeezed (that is, ovalized) relative to a rest position where each winding is circular in shape.

In particular, the spring (and/or the additional spring) comprises a plurality of windings. In other words, the spring extends along an axis of extension in which the plurality of windings is wound around the axis of extension. In particular, when the spring is closed on itself to a form a ring, the axis of extension of the spring is closed on itself. When the spring is at rest (that is, in the absence of forces acting radially towards the axis of extension), the centres of the windings may be disposed consecutively to each other to form a circle. In an example, when the spring is at rest (that is, in the absence of forces acting radially towards the axis of extension), the centres of the windings may be disposed consecutively to each other to form a helical shape. In particular, when the spring is at rest, the pitch between one helix and the next is greater than the pitch of the windings. Under preloaded conditions, that is, when there are forces acting radially towards the axis of extension, the helixes of the spring (and/or of the additional spring) may be forced to align so that the centres of the helixes are disposed consecutively to each other to form a circle.

In other words, the spring and/or the additional spring is located in the gap so that the centres of the helixes are disposed consecutively to each other to form a circle. This allows the guiding device to be preloaded in a particularly easy, reliable manner.

In an embodiment, the loudspeaker comprises an inner body defining the inside surface. The inner body may be deformed along the radial direction in at least one portion of it which is in contact with the spring, so as to be compressed by a predetermined quantity relative to a rest position, along the radial direction.

In an example, the loudspeaker comprises an outer body defining the outside surface. The outer body may be deformed along the radial direction in at least one portion of it which is in contact with the spring, so as to be compressed by a predetermined quantity relative to a rest position, along the radial direction.

For this purpose, the inner body and/or the outer body may be made from an elastic material.

In an example, the inner body and/or the outer body comprises a plurality of slots. The slots may extend parallel to each other around the guide axis or they may extend along a helical shape around the guide axis. The slots have the function of allowing the inner body and/or the outer body to deform towards or away from the guide axis.

Preferably, the spring is configured to roll between a point of maximum travel and a point of minimum travel, defining between the point of maximum travel and the point of minimum travel, a total length of travel E. In particular, the point of maximum travel is located at a greater distance E/2 and the point of minimum travel is located at a smaller distance −E/2 from the rest point.

In an example, the guiding device is configured to attract the spring towards the rest point, that is, it is configured to limit the rolling of the spring between the point of maximum travel and the point of minimum travel and vice versa. For example, the outside surface of the guiding device extends towards the guide axis between the point of maximum travel and the rest point, and away from the guide axis between the point of minimum travel and the rest point. Therefore, the outside surface defines for the spring, a seat which has curving geometry. In addition or alternatively, the inside surface may extend between the point of maximum travel and the rest point and between the point of minimum travel and the rest point, away from the guide axis. That way, the inside surface defines for the spring, a seat which has curving geometry.

When the outside surface and the inside surface are both made this way, the outside surface and the inside surface define an hourglass-shaped seat for the spring.

Similarly, the outside surface and/or the inside surface may also define a seat for the additional spring, when present.

In an embodiment, the inside surface extends towards the guide axis between the point of maximum travel and the rest point and between the point of minimum travel and the rest point.

In an example, the loudspeaker comprises a magnet, located at the rest point, and the spring (and/or the additional spring) is made from ferromagnetic material to interact with the magnet. That way, the spring is attracted towards the rest point by the magnet. The magnet may be inserted inside an inner body that defines the inside surface of the guiding device, or it may be located outside an outer body that defines the outside surface of the guiding device.

In an example, the spring comprises a plurality of windings, each defining a layer. Preferably, in the absence of external forces acting on the guiding device, the winding layers are oriented radially relative to the guide axis.

Responsive to an external force acting on the guiding device, preferably transversely to the guide axis, each of the plurality of windings may be configured to tilt its layer, at least for a time interval equal to the duration of the external force.

Preferably, the longitudinal axis is aligned with the guide axis, the outside surface is fixed to the movable working unit, in particular to the radiator and to the movable magnetic element, and the outside surface is fixed to the stationary structure. Preferably, the movable magnetic element is rigidly connected to the radiator.

In particular, the loudspeaker may comprise an inner body defining the inside surface of the guiding system. The inner body may form part of the movable working unit of the loudspeaker. The inner body may have a cylindrical cross section or a cross section with any other shape: for example, the cross section may be square with rounded corners to allow the spring to roll. Preferably, the loudspeaker comprises an outer body defining the outside surface of the guiding system. The outer body may form part of the stationary structure of the loudspeaker. The outer body may have a cross section which is circular or square with rounded corners to allow the spring to roll.

In particular, the inner body may be made from ferromagnetic material, to enable it to be traversed by the magnetic field generated by the magnetic field generator. In an example, the inner body defines a seat for the outer body. The outer body is movably housed in the seat in the inner body. The outer body may comprise an outside wall and the movable magnetic element may be integral with the outside wall of the outer body. The outer body may be integral with the radiator. That way, the movable magnetic element transfers the movement to the radiator.

This disclosure also provides a method for spreading a sound. The method comprises a step of providing a stationary structure, including a magnetic field generator, and a movable working unit, including a movable magnetic element connected to the radiator. The method comprises a step of generating a magnetic field via the magnetic field generator ad moving the movable magnetic element responsive to the magnetic field generated in order to move the radiator along a longitudinal axis.

The method comprises a step of guiding the longitudinal movement of the movable working unit via a guiding device. The guiding device may be made according to one or more aspects of this disclosure. Preferably, the guiding device comprises an inside surface, extending around a guide axis oriented longitudinally, and an outside surface, extending around the guide axis and surrounding the inside surface to define a gap. The guiding device comprises a spring, closed on itself to form a ring, disposed in the gap in contact with the inside surface and with the outside surface.

In particular, the step of guiding occurs by rolling the spring on the inside surface and outside surface, moving longitudinally responsive to a relative movement between the inside surface and the outside surface, where the inside surface is connected to the stationary structure and the outside surface is connected to the movable working unit, or vice versa.

In an example embodiment, the guiding device comprises an additional spring, closed on itself to form a ring, disposed in the gap in contact with the inside surface and with the outside surface. Preferably, the step of guiding occurs by rolling the additional spring on the inside surface and outside surface, moving longitudinally responsive to a relative movement between the inside surface and the outside surface, where the spring and the additional spring define a pair of springs.

In an example, the pair of springs is electrically conductive; the movable magnetic element is a coil, extending between a first end and a second end. The method may comprise a step of providing a positive terminal and a negative terminal and generating current via a current generator connected to the positive terminal and to the negative terminal.

The method may comprise a step of carrying current between the positive terminal and the spring and between the negative terminal and the additional spring along an internal conductive path defined by the inside surface, and carrying current between the spring and the first end of the coil and between the additional spring and the second end of the coil along an external conductive path defined by the outside surface.

In an example, the method comprises a step of preloading the guiding system along a radial direction towards the guide axis or away from the guide axis.

In an example, the spring is configured to roll between a point of maximum travel and a point of minimum travel and defines, between the point of maximum travel and the point of minimum travel, a total length of travel E, the point of maximum travel being located at a greater distance E/2 and the point of minimum travel being located at a smaller distance −E/2 from a rest point. The method may comprise an action (that is, a force) of attraction of the spring towards the rest point.

### BRIEF DESCRIPTION OF THE DRAWINGS

This and other features will become more apparent from the following description of a preferred embodiment, illustrated by way of non-limiting example in the accompanying drawings, in which:

FIGS. 1A-5A and 1B-5B show cross sections of a loudspeaker according to one or more aspects of this disclosure;

FIGS. 6A, 6B, 7-15, 16A, 16B and 17 show a guiding device according to one or more aspects of this disclosure;

FIGS. 18A-18C show a spring according to one or more aspects of this disclosure.

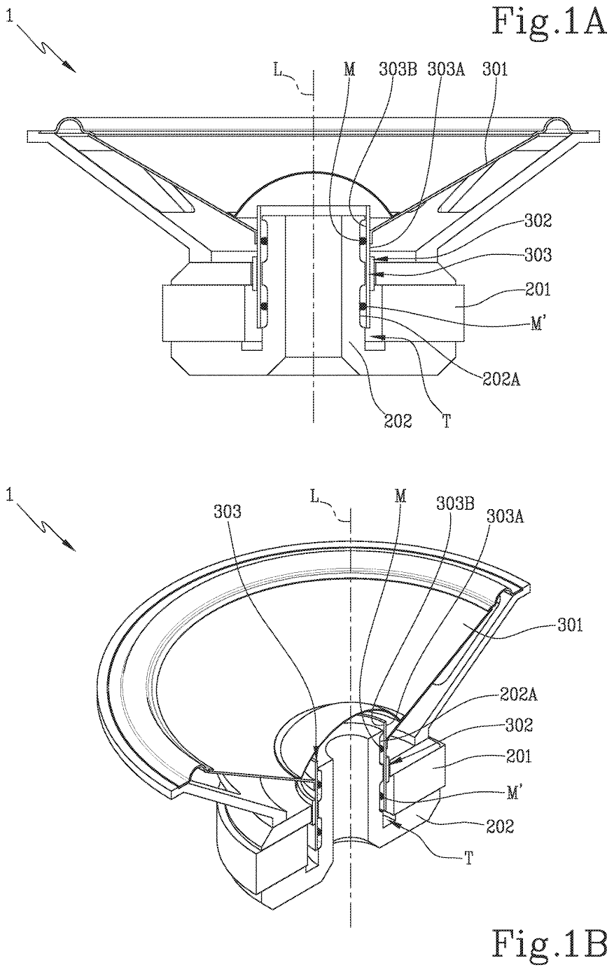

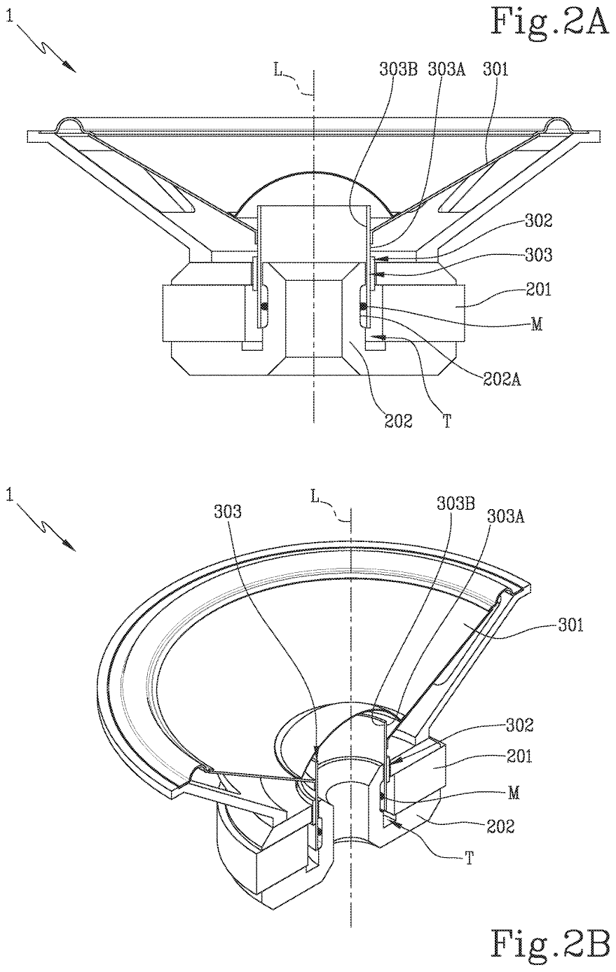

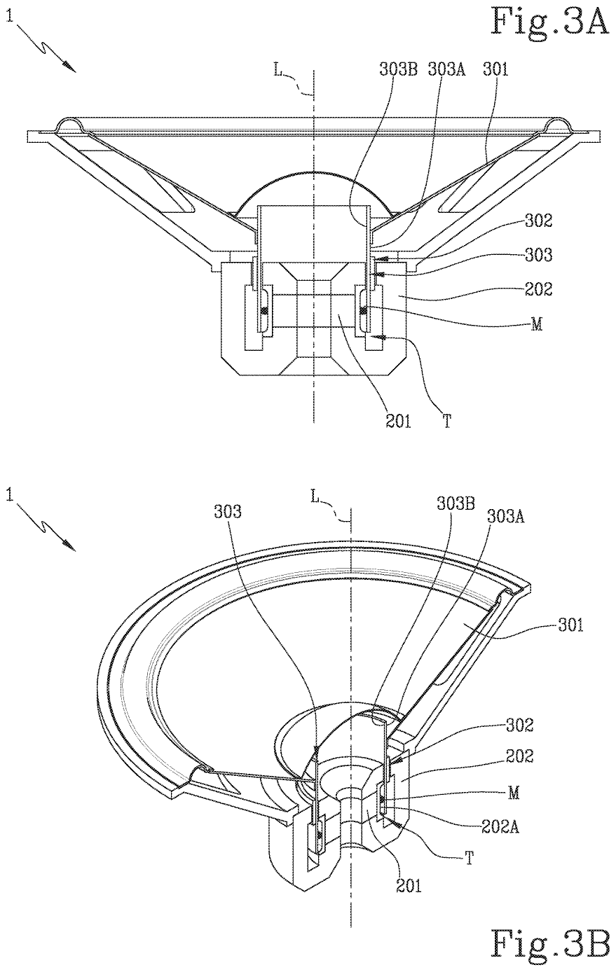

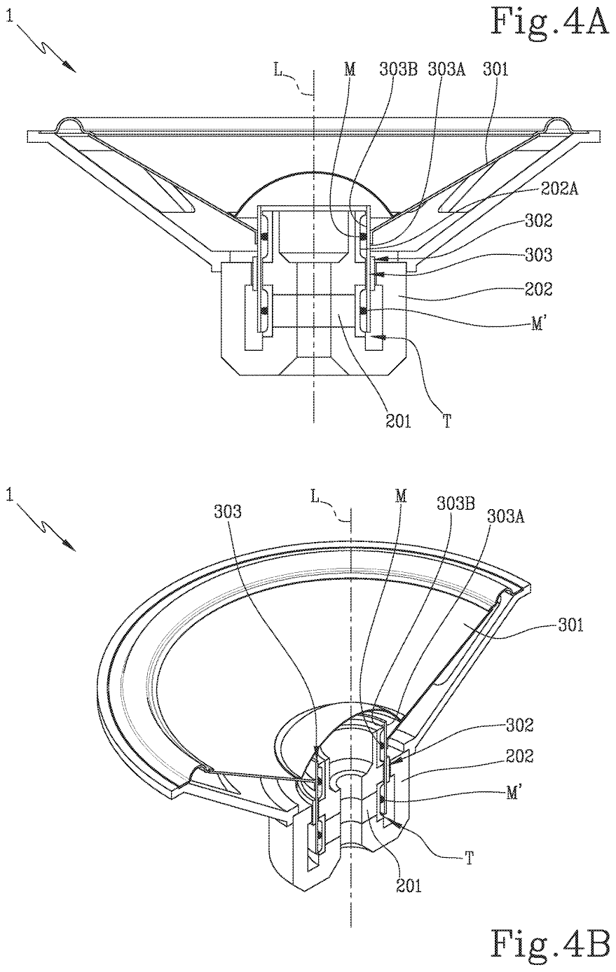

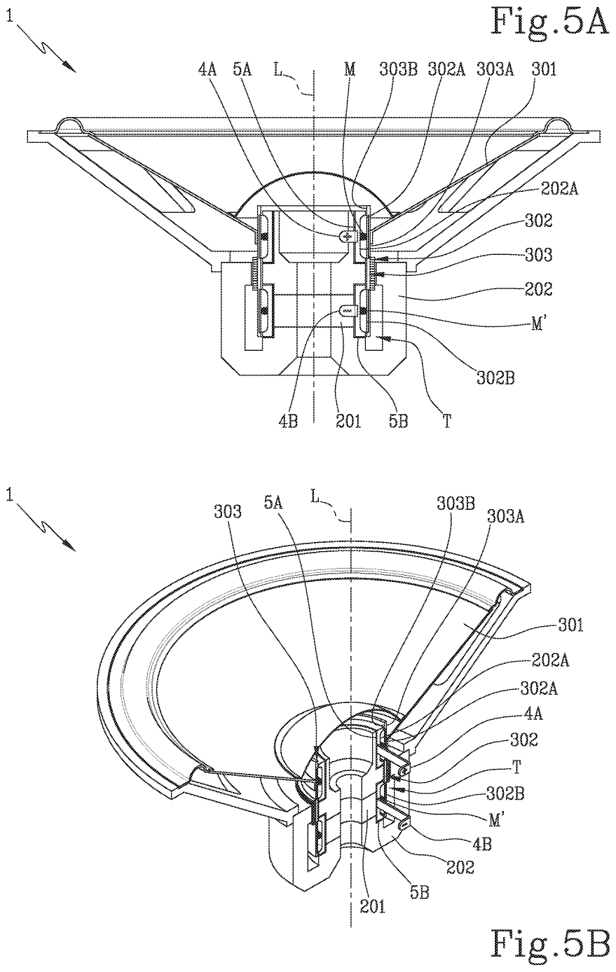

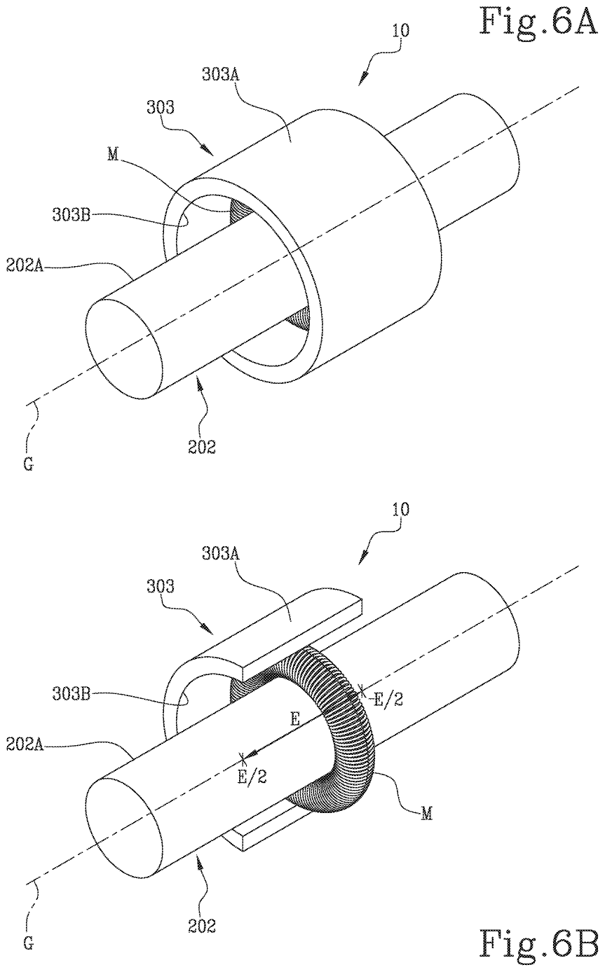

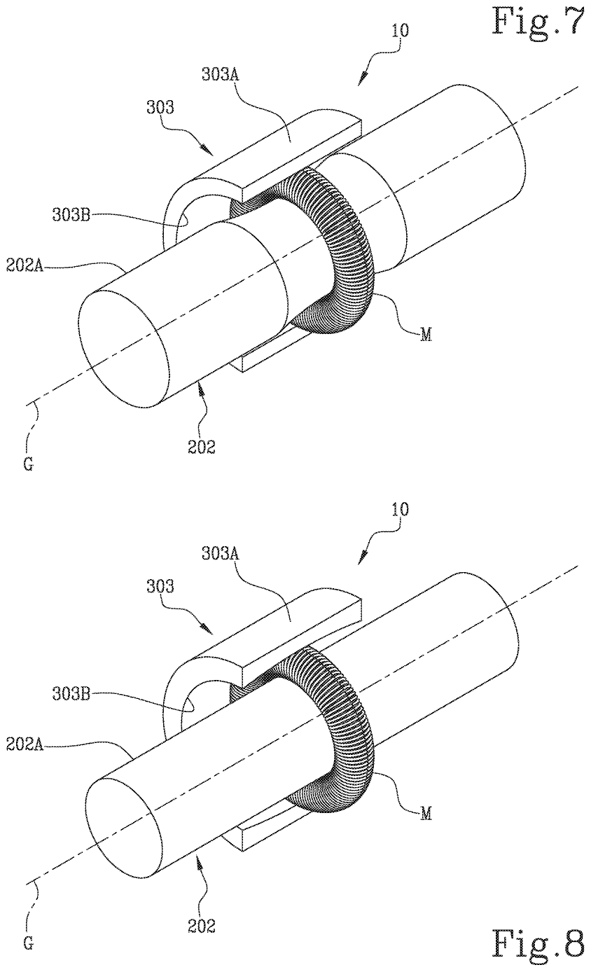

### DETAILED DESCRIPTION OF PREFERRED EMBODIMENTS OF THE INVENTION

The following description deals, for the most part, with a loudspeaker of the moving coil type; however, many of the aspects described, especially with reference to the guiding device, are understood as being applicable also to loudspeakers of the moving magnet type. The numeral 1 in the accompanying drawings denotes a loudspeaker. The loudspeaker 1 comprises a stationary structure, including a magnetic field generator 201. The magnetic field generator is a permanent magnet. The stationary structure comprises an inner body 202. The inner body 202 can be magnetized so as to transmit the magnetic field generated by the permanent magnet 201. In other words, the inner body 202 constitutes a magnetic core.

The diffuser 1 comprises a movable working unit. The movable working unit includes a radiator 301 movable along a longitudinal axis L and a movable magnetic element 302. The movable magnetic element 302 is a coil. The movable magnetic element 302 is connected to the radiator 301 and movable under the action of the magnetic field generated by the permanent magnet 201 to form, together with the permanent magnet 201, an electromechanical transducer for moving the radiator 301. The movable working unit includes an outer body 303. In some of the examples illustrated, the outer body 303 has a cylindrical shape extending around the longitudinal axis L. The outer body 303 defines an outside wall 303A and the coil of the movable magnetic element 302 comprises a plurality of windings wound around the outside wall 303A of the outer body 303 and connected as one with the outside wall 303A of the outer body 303. The movable magnetic element 302 is therefore connected to the radiator 301 by the outer body 303.

The inner body 202 defines a seat T surrounding the longitudinal axis L and configured to house the outer body 303 and the movable magnetic element 302. The seat T also acts as an air gap. The seat T includes an abutment surface for the inner body 202. Thus, the outer body 303 is located inside the seat T of the inner body 202 so as to be able to move along the longitudinal direction. In effect, when the coil 302 is traversed by the electrical signal, it moves inside the seat T under the action of the magnetic field generated by the permanent magnet 201 along the longitudinal direction L, moving the inner body 202 and the radiator 301.

The loudspeaker 1 comprises a guiding device 10 for guiding the longitudinal reciprocating movement of the movable working unit relative to the stationary structure. In particular, the guiding device 10 comprises an inside surface 202A defined by the inner body 202 of the stationary structure. The inside surface 202A extends around a guide axis G which, when the guiding device 10 forms part of the loudspeaker 1, coincides with the longitudinal axis L.

The guiding device 10 comprises an outside surface 303B defined by the outer body 303 of the movable working unit. The outside surface 303B extends around the guide axis G, that is, around the longitudinal axis L. In particular, the outside surface 303B surrounds the inside surface 202A in such a way as to define a gap.

The guiding device 10 comprises a spring M, closed on itself to form a ring, disposed in the gap in contact with the inside surface 202A and with the outside surface 303B to roll on them around the longitudinal axis L.

The guiding device 10 may comprise an additional spring M′, closed on itself to form a ring, disposed in the gap in contact with the inside surface 202A and with the outside surface 303B to roll on them around the longitudinal axis L.

In the description which follows, the aspects described with reference to the spring M are, unless otherwise specified, also applicable to the additional spring M′.

The inside surface 202A is connected to the stationary structure and the outside surface 303B is connected to the movable working unit; thus, when the movable working unit moves longitudinally, the spring M rolls between the inside surface 202A and the outside surface 303B.

The spring M is configured to roll between a point of maximum travel and a point of minimum travel. Between the point of maximum travel and the point of minimum travel, the spring M defines a total length of travel E. The point of maximum travel is located at a greater distance E/2 and the point of minimum travel is located at a smaller distance −E/2 from the rest point.

Preferably, the guiding device 10 is preloaded along a radial direction towards the guide axis G or away from the guide axis G, where the radial direction is perpendicular to the guide axis G. The guiding device 10 may be configured to attract the spring M towards the rest point.

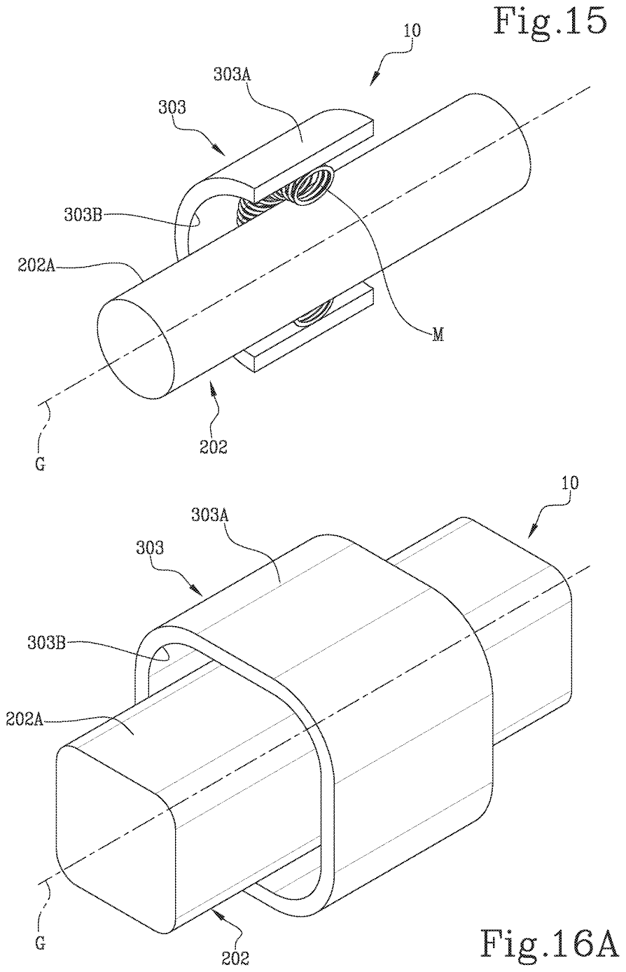

As illustrated schematically and purely by way of example in FIG. 15, preloading may be accomplished by locating the spring M in the gap so that the windings are compressed along the radial direction by a predetermined quantity relative to a rest position; thus, the winding layers have an oval (or elliptic) shape elongated along the guiding direction given by the guide axis G, relative to the direction radial to the guide axis G.

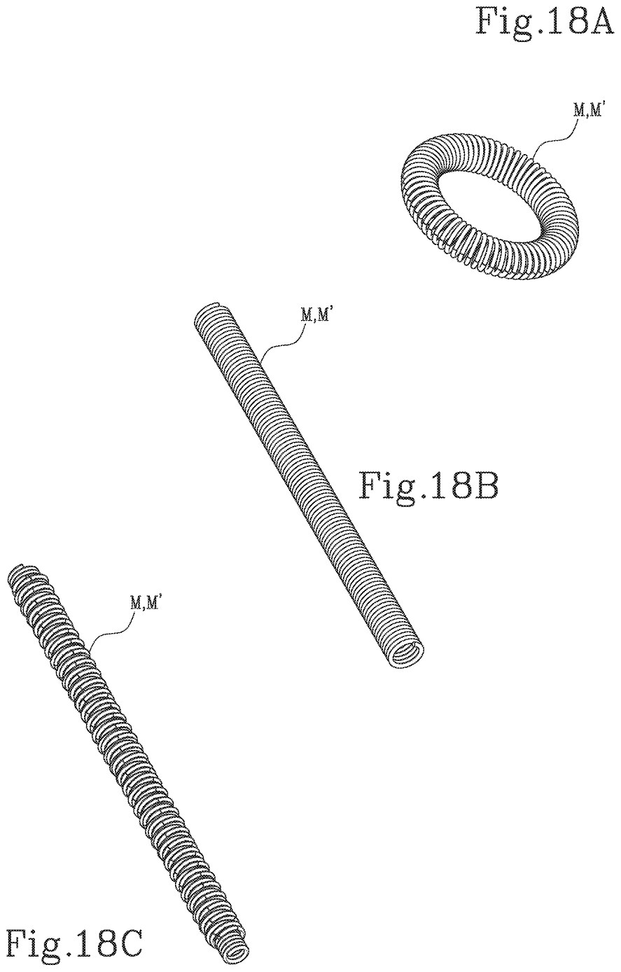

FIG. 18A illustrates a spring M which is closed on itself to form a ring. The centres of the windings of the spring M may be disposed consecutively to each other to form a circle, as illustrated in FIG. 18A. FIG. 18B illustrates an example of a spring M which is not closed on itself, where the centres are disposed consecutively to each other along a straight line. FIG. 18C illustrates another example of a spring M (which is not closed on itself), where the centres of the windings are disposed consecutively to each other to form a helical shape. When the spring is at rest, the pitch between one helix and the next is greater than the pitch of the windings. To create the preloading (that is, under preloading conditions), the helixes of the spring M are forced to align on a single line.

FIGS. 8-12 illustrate, schematically and purely by way of example, further examples of creating the preloading in radial direction. FIG. 8 shows an example where the outside surface 303B of the outer body 303 is deformable along the radial direction in at least one portion of it which is in contact with the spring M; thus, in order to create the preloading, the outer body 303 is compressed by a predetermined quantity relative to a rest position, along the radial direction, away from the guide axis G.

According to an aspect of this disclosure, there is also a centring system for centring the spring inside its seat, to exert on the spring a force of attraction which tends to bring it (and, in the absence of external forces acting on the inside and/or outside surfaces, does bring it) to the central rest position. This centring system may be embodied in various different ways. For example, there is a magnet at a stationary position; in addition or alternatively, there are slots on the inside and/or outside surfaces which cause these surfaces to be elastically deformable along the radial direction to a variable extent which is maximum at the rest position and minimum at the positions of maximum or minimum travel; in addition or alternatively, the inside and/or outside surfaces may be curved in such a way as to form a cradle-like shape, relative to which the rest position is, for the spring, the (only) position of stable equilibrium.

For example, FIG. 8 shows an example of the spring M being attracted towards the rest point. In effect, the outside surface 303B of the outer body 303 extends between the point of maximum travel and the rest point and between the point of minimum travel and the rest point, away from the guide axis G, so that when the spring M is at the point of maximum travel or at the point of minimum travel, it is attracted towards the rest point by the outside surface 303B.

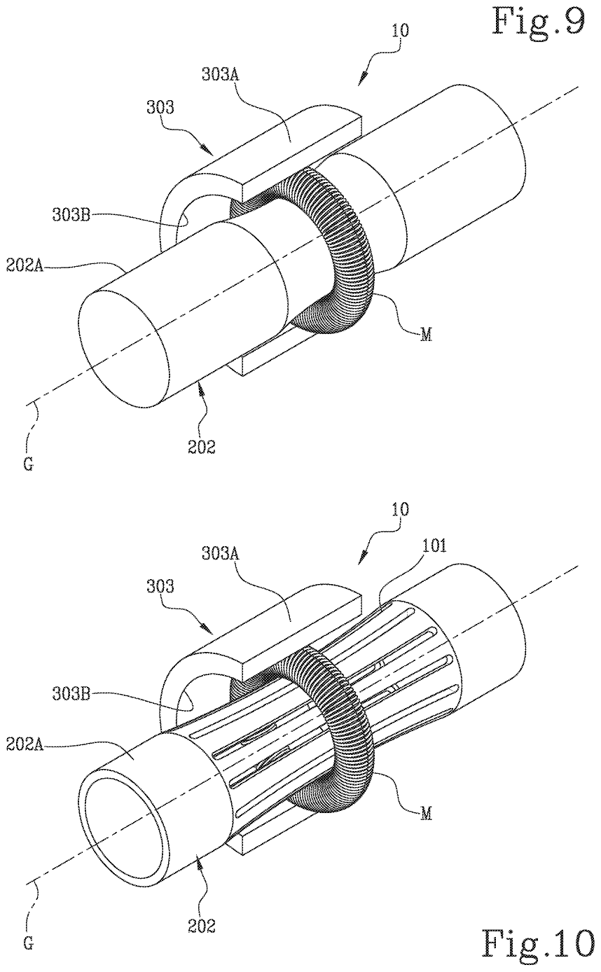

FIG. 9 shows an example where the inside surface 202A of the inner body 202 is deformable along the radial direction in at least one portion of it which is in contact with the spring M; thus, in order to create the preloading, the inner body 202 is compressed by a predetermined quantity relative to a rest position, along the radial direction, towards the guide axis G.

For example, FIG. 9 also shows an example of the spring M being attracted towards the rest point. In effect, the inside surface 202A extends between the point of maximum travel and the rest point and between the point of minimum travel and the rest point, towards the guide axis G, so that when the spring M is at the point of maximum travel or at the point of minimum travel, it is attracted towards the rest point by the inside surface 202A.

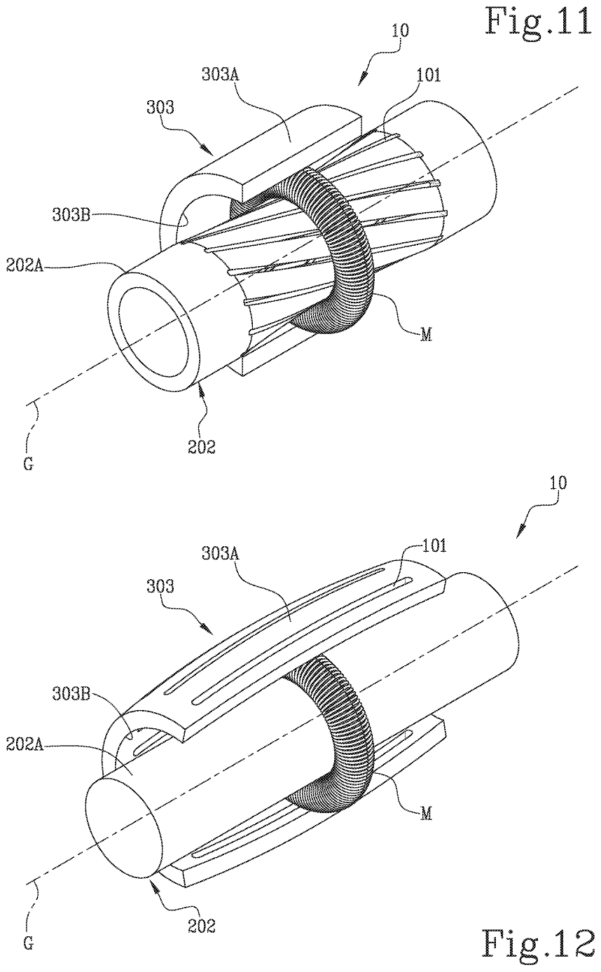

FIGS. 10, 11 and 12 illustrate example embodiments where the inner body 202 or the outer body 303 comprises a plurality of slots 101 extending around the guide axis G. The slots 101 allow the inner body 202 or the outer body 303 to be compressed radially, towards or away from the guide axis G, in order to create the preloading in radial direction. In FIG. 10, the inner body 202 comprises a plurality of slots 101 extending parallel to the guide axis G; under preloading conditions, the slots 101 allow the inner body 202 to be compressed towards the guide axis G. In FIG. 11, the slots 101 extend along a helical shape around the guide axis G. In FIG. 12, the outer body 303 comprises a plurality of slots 101 extending parallel to the guide axis G; under preloading conditions, the slots 101 allow the outer body 303 to be compressed away from the guide axis G.

FIGS. 10, 11 and 12 also show examples of how the spring M can be attracted towards the rest point. In effect, when the spring M Is at the point of maximum travel or at the position of minimum travel, it is attracted towards the rest point thanks to the slots 101 allowing the inner body 202 or the outer body 303 to be compressed respectively towards or away from the guide axis G.

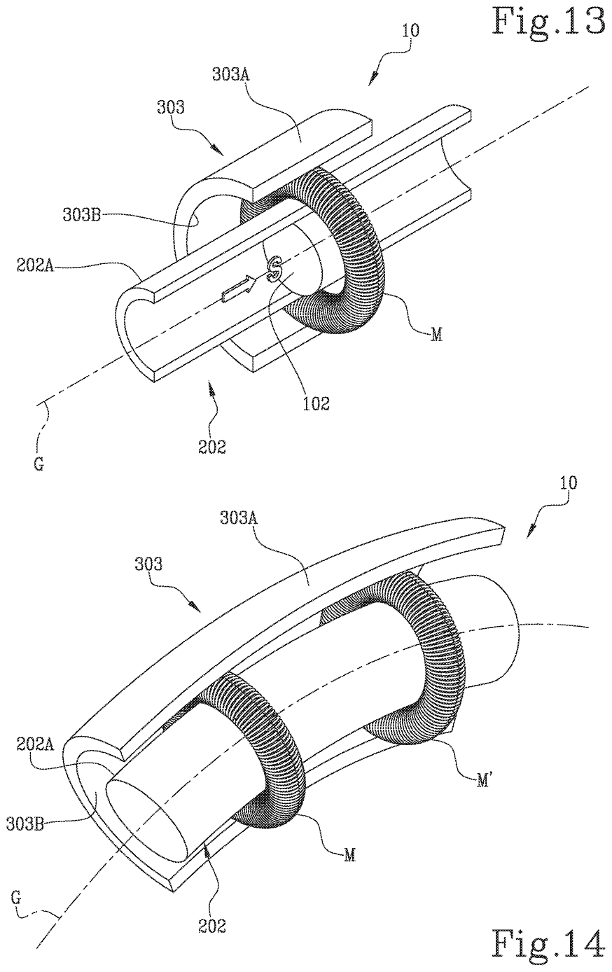

In another example, illustrated in FIG. 13, of how the spring M can be attracted towards the rest point, the guiding device 10 comprises a magnet 102, located at the rest point, and the spring M is made from ferromagnetic material to interact with the magnet 102. In the example illustrated, the magnet 102 is inserted inside the inner body 202, but it might also be located outside the outer body 303, that is to say, facing towards the inside surface 303A of the outer body 303. In particular, the magnet 102 attracts the spring M towards the rest point.

In an example, the loudspeaker 1 comprises a positive terminal 4A and a negative terminal 4B, both configured for receiving current from a current generator, and the spring M and additional spring M′ are electrically conductive. The coil 302 extends between a first end 302A and a second end 302B. The spring M is in electrical contact with the positive terminal 4A and in contact with the first end 302A of the coil 302. The additional spring M′ is in electrical contact with the negative terminal 4B and in contact with the second end 302B of the coil 302. The loudspeaker comprises a first electrically insulating element 5A and a second electrically insulating element 5B. The first electrically insulating element 5A is located on the inside surface 202A of the inner body 202, between the inside surface 202A and the spring M in contact with the positive terminal 4A, so as to insulate the inner body 202 electrically from the spring M. The second electrically insulating element 5B is located on the inside surface 202A of the inner body 202, between the inside surface 202A and the additional spring M′ in contact with the negative terminal 4B, so as to insulate the inner body 202 electrically from the additional spring M'. Thus, when the positive terminal 4A and the terminal 4B receive current from a generator, the spring M and the additional spring M′ transfer current to the coil 302.

FIG. 14 illustrates, purely by way of example, a guiding device 10 where the inner body 202 and the outer body 303 extend around the guide axis G, and where the guide axis G has a curved direction.

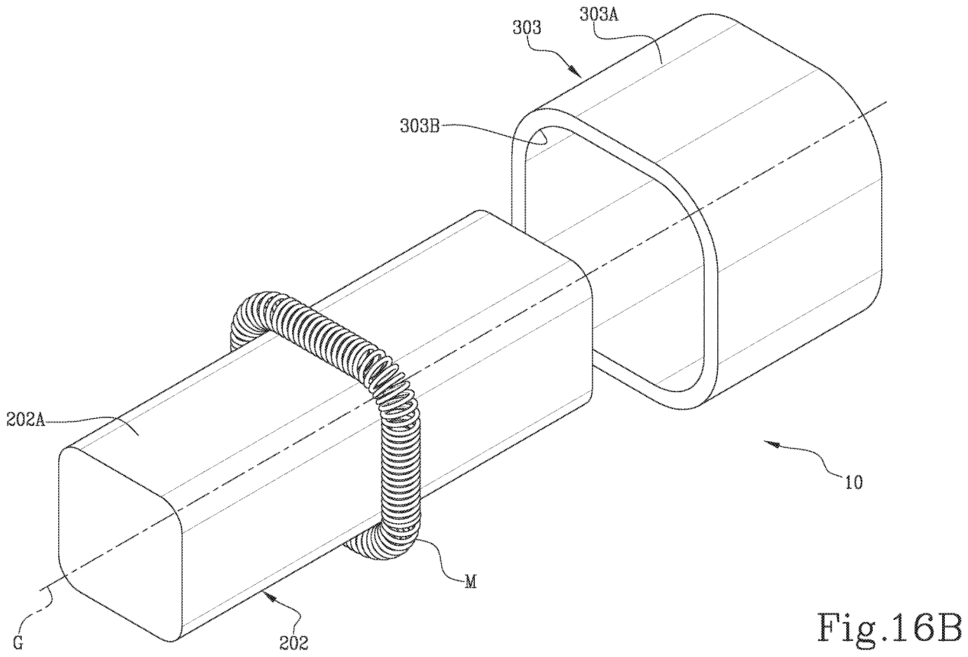

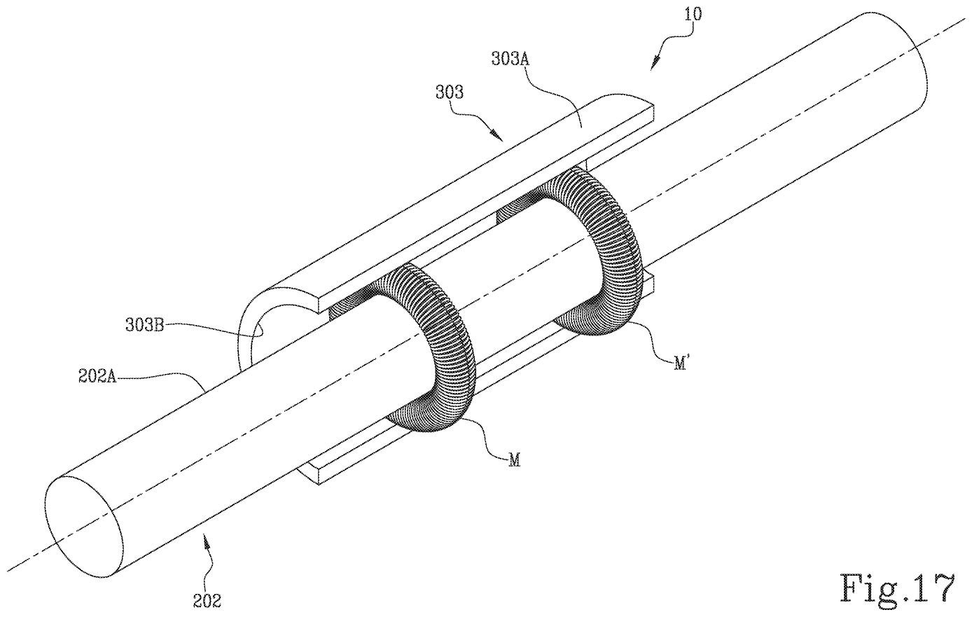

FIGS. 16A and 16B illustrate an example where the inner body 202 and the outer body 303 have a square cross section, with rounded corners to allow the spring M to roll.

The following paragraphs, listed in alphanumeric order for reference, are non-limiting example modes of describing a guiding device.

A. A guiding device 10 comprising:
an inside surface 202A, extending around a guide axis G;
an outside surface 303B, extending around the guide axis G and surrounding the inside surface 202A to define a gap;
a spring M, closed on itself to form a ring, disposed in the gap in contact with the inside surface 202A and the outside surface 303B to roll on them while moving along the guiding direction responsive to a relative movement between the outside surface 303B and the inside surface 202A.

A.1. The guiding device 10 according to paragraph A, comprising an additional spring M′, closed on itself to form a ring, disposed in the gap in contact with the inside surface 202A and the outside surface 303B to roll on them while moving along the guiding direction responsive to a relative movement between the inside surface 202A and the outside surface 303B, the spring M and the additional spring M′ defining a pair of springs.

A.2. The guiding device 10 according to paragraph A or paragraph A.1, wherein the spring M is electrically conductive.

A.3. The guiding device 10 according to any of the paragraphs from A to A.2, preloaded along a radial direction towards the guide axis G or away from the guide axis G.

A.3.1. The guiding device 10 according to paragraph A.3, wherein the spring M is located in the gap so as to be compressed by a predetermined quantity relative to a rest position, along the radial direction.

A.3.1.1. The guiding device 10 according to paragraph A.3.1, wherein the spring M comprises a plurality of windings, the centres of the windings being disposed consecutively to each other to form a helical shape, and wherein, at the rest position of the spring M, the pitch of the helix is greater than the pitch of the windings.

A.3.2. The guiding device 10 according to any of the paragraphs from A.3 to A.3.1.1, comprising an inner body 202 defining the inside surface 202A, the inner body 202 being deformable along the radial direction in at least one portion of it which is in contact with the spring M, so as to be compressed by a predetermined quantity relative to a rest position, along the radial direction.

A.3.3. The guiding device 10 according to any of the paragraphs from A.3. to m A.3.2, comprising an outer body 303 defining the outside surface 303B, the outer body 303 being deformable along the radial direction in at least one portion of it which is in contact with the spring M, so as to be compressed by a predetermined quantity relative to a rest position, along the radial direction.

A.3.3.1. The guiding device 10 according to paragraph A.3.2 or paragraph A.3.3, wherein the inner body 202 or the outer body 303 comprises a plurality of slots 101.

A.3.3.1.1. The guiding device 10 according to paragraph A.3.3.1, wherein the slots 101 extend along a helical shape around the guide axis G.

A.4. The guiding device 10 according to any of the paragraphs from A to

A.3.3.1.1, wherein the spring M is configured to roll between a point of maximum travel and a point of minimum travel and defines, between the point of maximum travel and the point of minimum travel, a total length of travel E, the point of maximum travel being located at a greater distance E/2 and the point of minimum travel being located at a smaller distance −E/2 from a rest point.

A.4.1. The guiding device 10 according to paragraph A.4, wherein the guiding device 10 is configured to attract the spring M towards the rest point.

A.4.1.1. The guiding device 10 according to paragraph A.4.1., wherein the inside surface 202A extends between the point of maximum travel and the rest point and between the point of minimum travel and the rest point, towards the guide axis G.

A.4.1.2. The guiding device 10 according to paragraph A.4.1. or paragraph A.4.1.1, wherein the outside surface 303B extends between the point of maximum travel and the rest point and between the point of minimum travel and the rest point, away from the guide axis G.

A.4.1.3. The guiding device 10 according to any of the paragraphs from A.4.1. to A.4.1.2, comprising a magnet 102, located at the rest point, and the spring is made from ferromagnetic material to interact with the magnet 102.

B A method for making a guide, comprising the following steps:
providing an inside surface 202A, extending around a guide axis G;
providing an outside surface 303B, extending around the guide axis G and surrounding the inside surface 202A to define a gap;
providing a spring M, closed on itself to form a ring, disposed in the gap in contact with the inside surface 202A and with the outside surface 303B;
moving the inside surface 202A and the outside surface 303B relative to each other;
rolling the spring on the inside surface 202A and on the outside surface 303B along the guiding direction, responsive to the relative movement between the inside surface 202A and the outside surface 303B.

B.1. The method according to paragraph B, comprising the following steps:
providing an additional spring M', closed on itself to form a ring, disposed in the gap in contact with the inside surface 202A and with the outside surface 303B;
rolling the additional spring M′ on the inside surface 202A and on the outside surface 303B along the guiding direction, responsive to the relative movement between the inside surface 202A and the outside surface 303B.

B.2. The method according to paragraph B or paragraph B.1, wherein the spring M is electrically conductive and the method comprises a step of conducting current from the inside surface 202A to the outside surface 303B through the spring M.

B.3. The method according to any one of paragraphs B to B.2, comprising a step of preloading along a radial direction towards the guide axis G or away from the guide axis G.

B.3.1. The method according to paragraph B.3, comprising a step of compressing the spring M by a predetermined quantity relative to a rest position, along the radial direction.

B.3.1.1. The method according to paragraph B.3.1, wherein the spring M comprises a plurality of windings, the centres of the windings being disposed consecutively to each other to form a helical shape, and wherein, at the rest position of the spring M, the pitch of the helix is greater than the pitch of the windings, wherein the step of compressing comprises aligning the helixes in such a way that the centres of the helixes are disposed consecutively to each other to form a circle.

B.3.2. The method according to any of the paragraphs from B.3. to B.3.1.1, comprising the following steps:
providing an inner body 202 defining the inside surface 202A;
deforming the inner body 202 along the radial direction in at least one portion of it which is in contact with the spring M, so as to be compressed by a predetermined quantity relative to a rest position, along the radial direction.

B.3.3. The method according to any of the paragraphs from B.3. to B.3.2, comprising the following steps:
providing an outer body 303 defining the outside surface 303B;
deforming the outer body 303 along the radial direction in at least one portion of it which is in contact with the spring M, so as to be compressed by a predetermined quantity relative to a rest position, along the radial direction.

B.3.3.1. The method according to paragraph B.3.2 or paragraph B.3.3, wherein the inner body 202 or the outer body 303 comprises a plurality of slots 101.

B.3.3.1.1. The method according to paragraph B.3.3.1, wherein the slots 101 extend along a helical shape around the guide axis G.

B.4. The method according to any of the paragraphs from B to B.3.3.1.1, wherein the spring M rolls between a point of maximum travel and a point of minimum travel and defines, between the point of maximum travel and the point of minimum travel, a total length of travel E, the point of maximum travel being located at a greater distance E/2 and the point of minimum travel being located at a smaller distance −E/2 from a rest point.

B.4.1. The method according to paragraph B.4, comprising an action of attracting the spring M towards the rest point.

B.4.1.1. The method according to paragraph B.4.1., wherein the inside surface 202A extends between the point of maximum travel and the rest point and between the point of minimum travel and the rest point, towards the guide axis G.

B.4.1.2. The method according to paragraph B.4.1. or paragraph B.4.1.1, wherein the outside surface 303B extends between the point of maximum travel and the rest point and between the point of minimum travel and the rest point, away from the guide axis G.

B.4.1.3. The method according to any of the paragraphs from B.4.1. to B.4.1.2, comprising the following steps:
providing a magnet 102 at the rest point;
interaction between the spring M and the magnet 102, wherein the spring M is made from ferromagnetic material.

1. A loudspeaker, comprising:
a stationary structure, including a magnetic field generator;
a movable working unit, including a radiator, movable along a longitudinal axis, and a movable magnetic element, connected to the radiator and movable under the action of the magnetic field to form a transducer;
a guiding device configured to guide the longitudinal reciprocating movement of the movable working unit,
wherein the guiding device includes:
an inside surface, extending around a guide axis (G) which is oriented longitudinally;
an outside surface extending around the guide axis and surrounding the inside surface to define a gap;
a spring, closed on itself to form a ring, disposed in the gap in contact with the inside surface and the outside surface to roll on them while moving longitudinally responsive to a relative movement between the inside surface and the outside surface, wherein the inside surface is connected to the stationary structure and the outside surface is connected to the movable working unit, or vice versa.

2. The loudspeaker according to claim 1, wherein the guiding device comprises an additional spring, closed on itself to form a ring, disposed in the gap in contact with the inside surface and the outside surface to roll on them while moving longitudinally responsive to a relative movement between the inside surface and the outside surface, the spring and the additional spring defining a pair of springs.

3. The loudspeaker according to claim 2, comprising a positive terminal and a negative terminal, both connectable to a current generator for receiving current, wherein:
the movable magnetic element is a coil, extending between a first end and a second end;
the pair of springs is electrically conductive;
the inside surface defines an internal conductive path to carry the current from the positive terminal to the spring and from the negative terminal to the additional spring and wherein the outside surface defines an external conductive path to carry the current from the spring to the first end of the coil and from the additional spring to the second end of the coil.

4. The loudspeaker according to claim 1, wherein the guiding device is preloaded along a radial direction towards the guide axis or away from the guide axis

5. The loudspeaker according to claim 4, wherein the spring is located in the gap so as to be compressed by a predetermined quantity relative to a rest position, along the radial direction.

6. The loudspeaker according to claim 5, wherein the spring comprises a plurality of windings, the centres of the windings being disposed consecutively to each other to form a helical shape, and wherein, at the rest position of the spring the pitch of the helix is greater than the pitch of the windings.

7. The loudspeaker according to claim 4,
wherein at least one of the following conditions is true:
i) the loudspeaker comprises an inner body defining the inside surface, wherein the inner body is deformable along the radial direction in at least one portion of it which is in contact with the spring, so as to be compressed by a predetermined quantity relative to a rest position, along the radial direction;
ii) the loudspeaker comprises an outer body defining the outside surface, wherein the outer body is deformable along the radial direction in at least one portion of it which is in contact with the spring, so as to be compressed by a predetermined quantity relative to a rest position, along the radial direction.

8. The loudspeaker according to claim 7, wherein the inner body or the outer body comprises a plurality of slots, extending along a helical shape around the guide axis.

9. The loudspeaker according to claim 1, wherein:
the spring is configured to roll between a point of maximum travel and a point of minimum travel and defines, between the point of maximum travel and the point of minimum travel, a total length of travel E, the point of maximum travel being located at a greater distance E/2 and the point of minimum travel being located at a smaller distance −E/2 from a rest point;
the guiding device being configured to attract the spring towards the rest point.

10. The loudspeaker according to claim 9, wherein at least one of the following conditions is true:
i) the inside surface extends between the point of maximum travel and the rest point and between the point of minimum travel and the rest point, towards the guide axis;
ii) the outside surface extends between the point of maximum travel and the rest point and between the point of minimum travel and the rest point, away from the guide axis;
iii) the loudspeaker comprises a magnet, located at the rest point, and the spring is made of ferromagnetic material to interact with the magnet.

11. The loudspeaker according to claim 1, wherein the longitudinal axis is aligned with the guide axis, the outside surface is fixed to the radiator and to the movable magnetic element and the inside surface is fixed to the stationary structure.

12. The loudspeaker according to claim 1, wherein the spring includes an annular shaped tubular element.

13. The loudspeaker according to claim 12, wherein the annular shaped tubular element is made from polymeric material.

14. A method for spreading a sound, comprising the following steps:
providing a stationary structure, including a magnetic field generator;
providing a movable working unit, including a radiator and a movable magnetic element, connected to the radiator;
generating a magnetic field via the magnetic field generator;
moving the movable magnetic element responsive to the magnetic field generated, so as to move the radiator along a longitudinal axis;
guiding the longitudinal movement of the movable working unit via a guiding device, wherein the guiding device comprises an inside surface, extending around a guide axis which is oriented longitudinally, an outside surface extending around the guide axis and surrounding the inside surface to define a gap, and a spring, closed on itself to form a ring, disposed in the gap in contact with the inside surface and the outside surface, wherein the step of guiding is accomplished by rolling the spring on the inside surface and on the outside surface while moving longitudinally responsive to a relative movement between the inside surface and the outside surface, wherein the inside surface is connected to the stationary structure and the outside surface is connected to the movable working unit, or vice versa.

15. The method according to claim 14, wherein:
the guiding device comprises an additional spring, closed on itself to form a ring, disposed in the gap in contact with the inside surface and the outside surface, wherein the step of guiding is accomplished by rolling the additional spring on the inside surface and on the outside surface while moving longitudinally responsive to a relative movement between the inside surface and the outside surface, the spring and the additional spring defining an electrically conductive pair of springs;
the movable magnetic element is a coil, extending between a first end and a second end,
the method comprising the following steps:
providing a positive terminal and a negative terminal;
generating current via a current generator connected to the positive terminal and to the negative terminal;
carrying current between the positive terminal and the spring and between the negative terminal and the additional spring along an internal conductive path defined by the inside surface, and carrying current between the spring and the first end of the coil and between the additional spring and the second end of the coil, along an external conductive path defined by the outside surface

16. The method according to claim 14, comprising a step of preloading the guiding system along a radial direction towards the guide axis or away from the guid axis.

17. The method according to claim 14, wherein the spring rolls between a point of maximum travel and a point of minimum travel and defines, between the point of maximum travel and the point of minimum travel, a total length of travel E, the point of maximum travel being located at a greater distance E/2 and the point of minimum travel being located at a smaller distance −E/2 from a rest point, the method comprising an action of attracting the spring towards the rest point.
